(19) United States
(12) Patent Application Publication
(10) Pub. No.: US 2026/0300558 A1
(43) Pub. Date: Oct. 1, 2026

(54) MOBILE DEVICE CONTENT SHARING WITH PRIVACY-FOCUSED NOTIFICATION MANAGEMENT

(71) Applicant: MOTOROLA MOBILITY LLC, WILMINGTON, DE (US)

(72) Inventor: JEEVITHA JAYANTH, BANGALORE (IN)

(21) Appl. No.: 19/094,960

(22) Filed: Mar. 30, 2025

(51) Int. Cl. G06F 21/84; G10L 13/08

(52) U.S. Cl. CPC G06F 21/84; G10L 13/08

(57) ABSTRACT

A method provides techniques for supporting a privacy-focused notification management (PFNM) mode of operation of an electronic device that presents visual content and notifications on a display. The electronic device detects a presence of multiple persons potentially viewing the display and enters a PFNM mode of operation. The electronic device detects a connection to at least one personal second electronic device, and on receipt of an incoming notification while in the PFNM mode of operation, analyzes the incoming notification for sensitive content. Based on the incoming notification being deemed to contain sensitive information, the notification is suppressed on the electronic device. A personal second electronic device is queried to determine an active usage status. If the personal second electronic device is currently being worn/used, data corresponding to the incoming notification is sent to the personal second electronic device to discreetly indicate the message to a user.

### BACKGROUND

### 1. Technical Field

The present disclosure generally relates to electronic devices, and more specifically to electronic devices that can render and present multimedia content and receive notifications.

### 2. Description of Related Art

Smartphones and tablet computers provide a convenient and versatile way to view multimedia content, making them essential devices for entertainment, communication, and learning. With their high-resolution screens and powerful processing capabilities, these devices enable users to watch a wide range of video content, including short-form videos, long-form videos, live events, and even full-length movies. Streaming services and social media platforms make it easy to access and share content anytime, anywhere. Additionally, smartphones and tablets allow people to watch videos together, by physically sharing the display screen with friends and family or using mirroring/projection options to present display content on a larger screen. This accessibility and flexibility make these devices ideal for entertainment, education, and staying connected with global events in real time.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2A illustrates an example environment in which privacy-focused notification management can be used, according to one or more embodiments;

FIG. 2B continues the example from FIG. 2A, indicating a potential reveal of sensitive information due to a surfaced notification on an electronic device;

FIG. 2C illustrates an example of privacy-focused notification based on the example shown in FIG. 2A, in which a notification is redirected to one or more personal second electronic devices, according to one or more embodiments;

FIG. 3 illustrates an exemplary user interface for privacy-focused notification management configuration, according to one or more embodiments;

FIG. 4 depicts a flowchart of a computer-implemented method for implementing privacy-focused notification management configuration on an electronic device, according to one or more embodiments; and

FIG. 5 depicts a flowchart of a computer-implemented method for additional embodiments for implementing privacy-focused notification management configuration on an electronic device, indicating details of sending audio, visual and/or haptic data, according to one or more embodiments.

### DETAILED DESCRIPTION

According to aspects of the present disclosure, an electronic device, a method, and a computer program product provide techniques for detecting a connection between the electronic device and at least one personal second electronic device that is being used by a primary user. A privacy-focused notification mode can be set on the electronic device based on determining that multiple people may be potentially able to view the display of the electronic device. With the privacy-focused notification mode, incoming notifications are redirected to a personal second electronic device that is being actively used by the primary user of the electronic device.

While watching videos on a smartphone or tablet with friends or coworkers can be a fun and engaging experience, it also comes with potential disadvantages, particularly regarding privacy and notifications. Many smartphones and tablets display incoming notifications, such as text messages, emails, or app alerts on screen, which could lead to unintended exposure of personal or sensitive information to those watching together. To mitigate these potential privacy issues, some devices offer “privacy modes” that suppress notifications while media is playing. However, this introduces another challenge: time-sensitive notifications, such as urgent work messages, emergency alerts, or important reminders, may be delayed or completely missed. Thus, there is a trade-off between maintaining privacy and ensuring timely access to critical information, making it difficult for users to strike the right balance, while enjoying video content with a group.

The disclosed embodiments address the aforementioned issues by enabling privacy-focused notification management. In embodiments, the electronic device may be manually put into the privacy-focused notification management mode. In one or more embodiments, the electronic device may automatically enter the privacy-focused notification management mode based on one or more user-based and/or environmental conditions. The conditions can include a playback status of a video, as well as if other people are determined to be nearby during the playback of a video. While in the privacy-focused notification management mode, notifications that are deemed to be sensitive and/or time critical are suppressed from being displayed on a display of the electronic device, and instead rerouted to a second, personal electronic device that is being use. The personal electronic device includes devices in which only the person using the device driver can detect the notification. Such personal electronic devices can include augmented-reality (AR) glasses, a smartwatch, wireless earbuds, and/or other wearable electronic devices.

According to one aspect, an incoming notification to an electronic device is detected and analyzed. In response to determining that the incoming notification is sensitive and/or time critical while the device display is being viewed by at least one other person who is not the primary user, the notification is suppressed from being rendered and presented on a display of the electronic device, and instead, is rerouted to a second, personal electronic device. As part of rerouting the notification, data is sent from the electronic device to the personal electronic device. The type of the personal electronic device can determine what types of data are sent from the electronic device to the personal electronic device and how the notification is presented on the personal electronic device. As an example, for AR glasses, visual data may be sent from the electronic device to the personal electronic device so that the notification can be viewed by the user wearing the AR glasses. Conversely, for wireless earbuds, audio data may be sent from the electronic device to the personal electronic device so that the notification can be indicated to the user wearing the wireless earbuds. The audio data can include a chime or tone to alert the user that a notification has been received. The audio data can include text-to-speech audio data that announces the contents of the notification to the user via the wireless earbuds. For a smartwatch, haptic data may be sent from the electronic device to the personal electronic device so that the notification can be indicated to the user wearing the smartwatch. The haptic data can serve as an alert to the user wearing the smartwatch that a notification has arrived. In some cases, multiple types of data may be sent from the electronic device to the personal electronic device. For example, in the case of a smartwatch, haptic and visual data may be sent to the smartwatch. In this way, a user can be alerted to incoming notifications discreetly, without disrupting the shared experience of viewing content on the electronic device.

One or more embodiments can provide an electronic device that includes: at least one output device comprising at least one display; a communications subsystem for communicatively connecting the electronic device with at least one second electronic device; a memory having stored thereon a privacy-focused notification management (PFNM) module; and at least one processor communicatively coupled to each of the at least one output device, the communications subsystem, and the memory, the at least one processor executing program code of the PFNM module and is configured to cause the electronic device to: detect a connection to at least one personal second electronic device; determine that the at least one display is potentially being viewed by at least one other person who is not the primary user; in response to determining that the at least one display is potentially being viewed by at least one other person who is not the primary user, enter a privacy-focused notification management (PFNM) mode of operation, while the connection to the at least one personal second electronic device is detected; receive an incoming notification; analyze the incoming notification to categorize the incoming notification into one of a first category of sensitive, personal/private, or security-related (SPS) notifications and a second category of general notifications; and based on the incoming notification being categorized into the first category: suppress the incoming notification from being presented on the electronic device; determine an active usage status for the at least one personal second electronic device; and transmit data corresponding to the incoming notification to the at least one personal second electronic device for presentation via the at least one personal second electronic device, in response to determining the at least one personal second electronic device is being used by a primary user.

One or more embodiments can provide a method that includes: detecting, by at least one processor of an electronic device that includes memory, at least one display, and communications subsystem for communicatively connecting the electronic device with at least one second electronic device, a connection to at least one personal second electronic device; entering a privacy-focused notification management (PFNM) mode of operation, while the connection to the at least one personal second electronic device is detected; receiving an incoming notification; analyzing the incoming notification to categorize the incoming notification into one of a first category of sensitive, personal/private, or security-related (SPS) notifications and a second category of general notifications; and based on the incoming notification being categorized into the first category: suppressing the incoming notification from being presented on the electronic device; determining an active usage status for the at least one personal second electronic device; and transmitting data corresponding to the incoming notification to the at least one personal second electronic device for presentation via the at least one personal second electronic device, in response to determining the at least one personal second electronic device is being used by a primary user.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

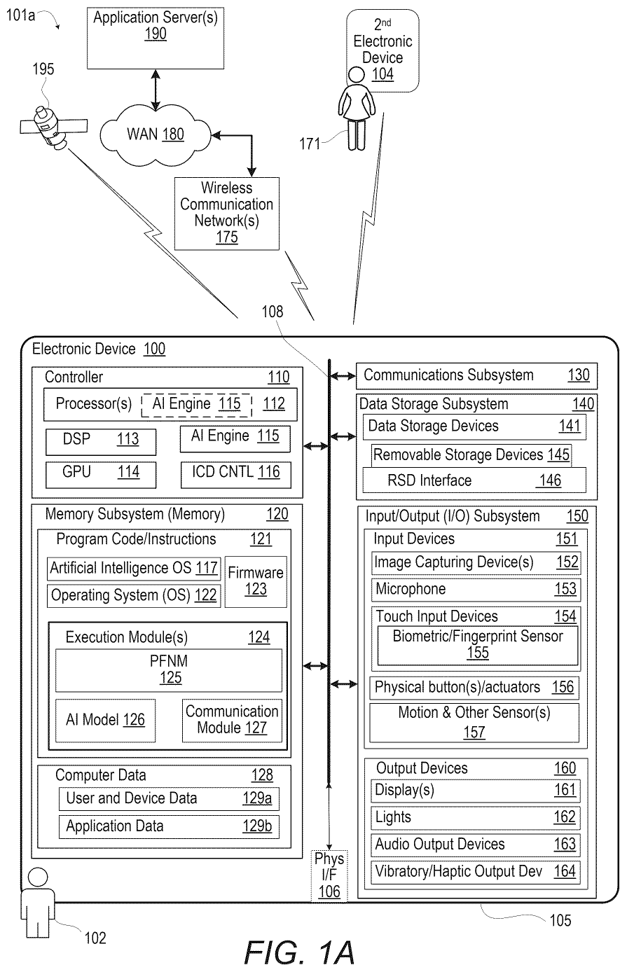

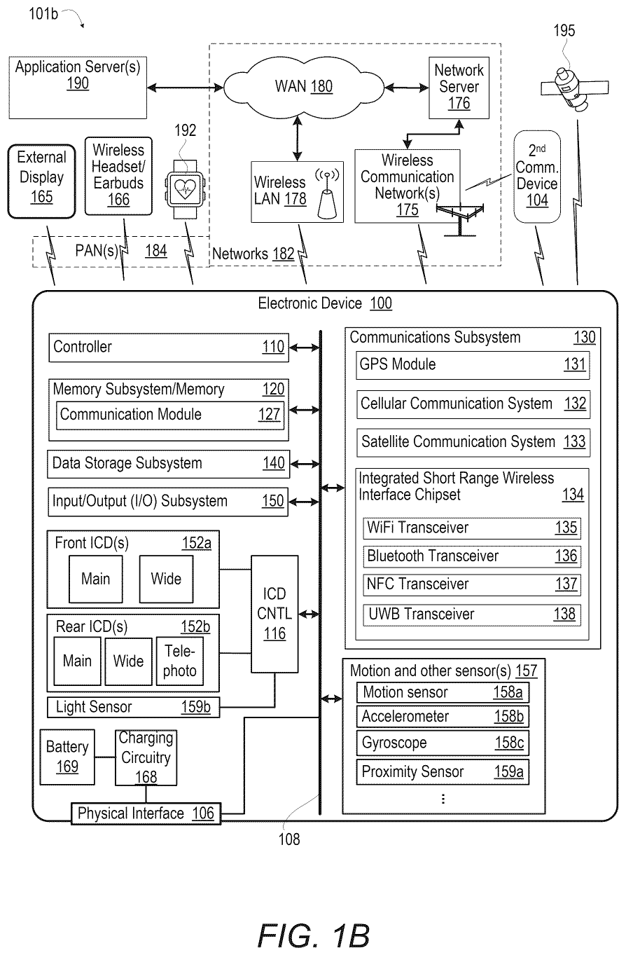

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, privacy-focused notification management (PFNM) module 125, which provides the features and operating functionality of the disclosed embodiments when the corresponding program instructions of privacy-focused notification management (PFNM) module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within PFNM module 125 and is trained to support AI features of PFNM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, PFNM module 125 can include program instructions that cause or configure processor 112 to cause electronic device 100 to redirect Sensitive, Personal/Private, or Security-related (SPS) messages and/or notifications to a second, personal electronic device, in order to maintain privacy while also enabling timely delivery of the information within the SPS messages and/or notifications. Other features provided by PFNM module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of PFNM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when a user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRx) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of PFNM module 125 and/or access to other applications, online transactions, and resources. In one or more embodiments, networks 182 can also include personal area networks (PAN) 184, which are individually created with second devices via one of short-range wireless devices from among Wi-Fi TxRx 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

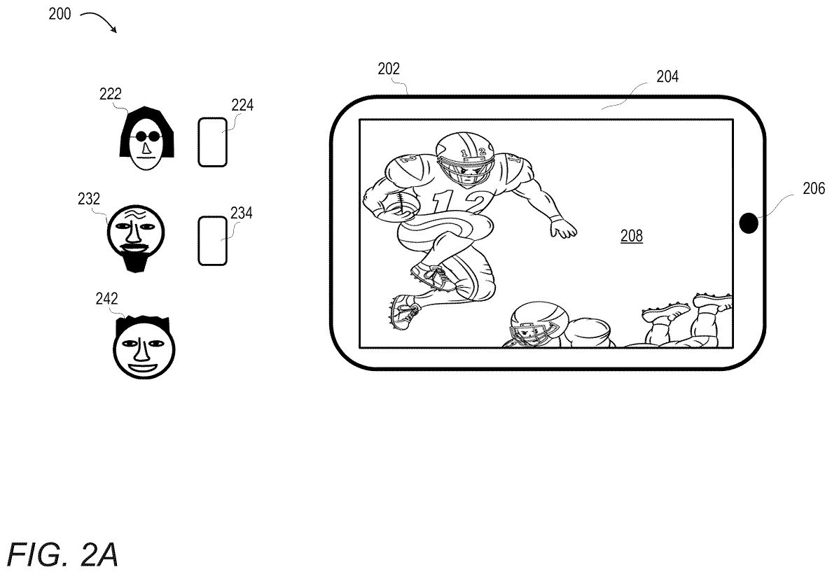

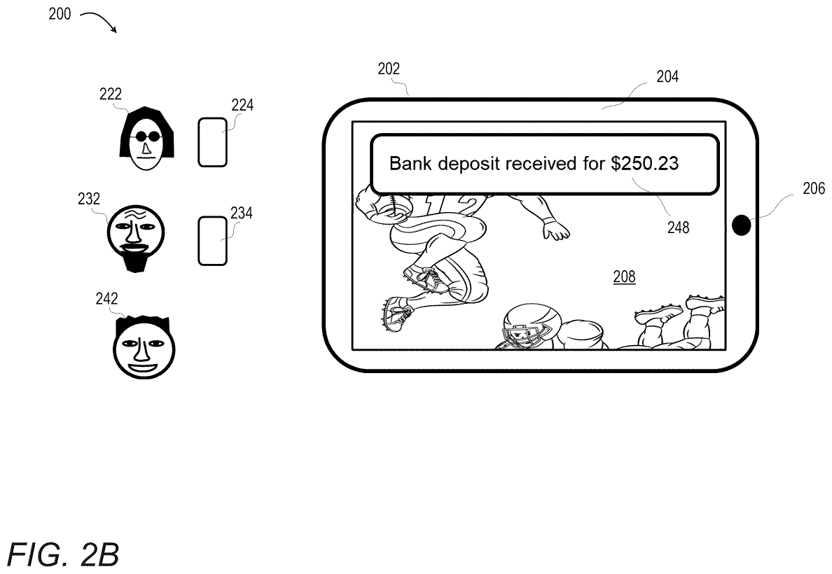

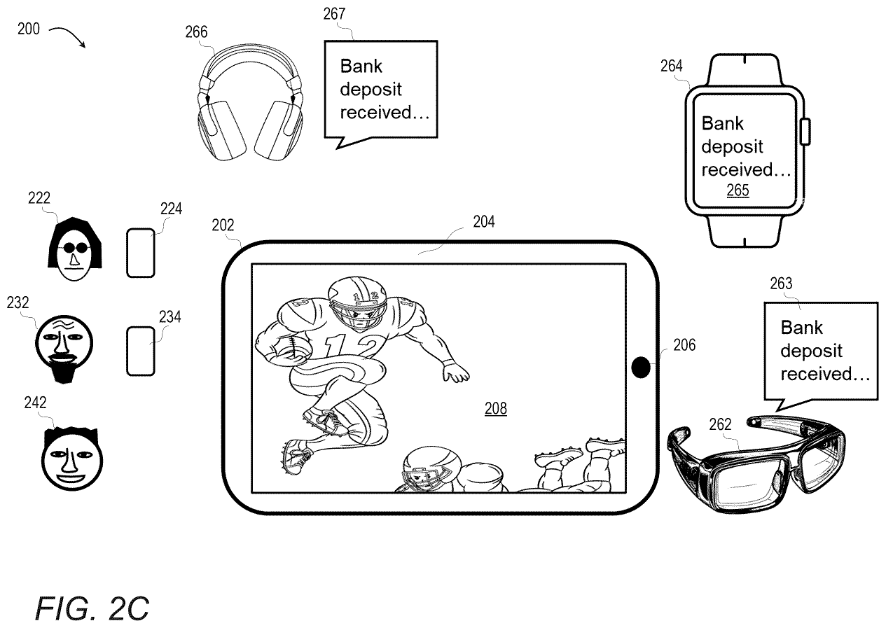

FIG. 2A illustrates an example environment in which privacy-focused notification management can be used, according to one or more embodiments. Environment 200 includes multiple people, indicated at 222, 232, and 242. Electronic device 224 is associated with person 222. Electronic device 234 is associated with person 232. Electronic device 202 is associated with person 242. Electronic device 202 may be similar to electronic device 100 depicted in FIG. 1A and FIG. 1B. Electronic device 202 includes electronic display 204 and camera 206. Content 208 is currently being rendered and presented on display 204. As shown in FIG. 2A, the three persons, 222, 232, and 242 are currently viewing content 208 together. FIG. 2B continues the example from FIG. 2A, indicating a potential reveal of sensitive information due to a surfaced notification on an electronic device. In a scenario where no privacy mode is enabled, a notification 248 may surface while persons 222, 232, and 242 are currently viewing content 208 together. The surfacing of notification 248 may reveal personal information to persons 222 and 232 that person 242 may prefer to keep private. While the person 242 may not wish to reveal the information contained in notification 248 to persons 222 and 232, it may be possible that person 242 is eagerly awaiting the notification. Thus, in a case where a typical “privacy mode” or “do not disturb” mode is activated, while application of the privacy mode may prevent the notification 248 from being surfaced, such as is depicted in FIG. 2B, the application has the disadvantage that person 242 may not receive the information contained in notification 248 in a timely manner, or may miss the information altogether.

FIG. 2C illustrates an example of privacy-focused notification based on the example shown in FIG. 2A, in which a notification is redirected to one or more personal second electronic devices, according to one or more embodiments. One or more embodiments can automatically detect multiple viewers by using a front-facing camera of the electronic device. One or more embodiments may utilize facial recognition and/or eye gaze tracking to determine the number of individuals actively looking at (or towards) the screen. Embodiments can utilize real-time image processing to detect and count faces, ensuring that only those whose gaze direction aligns with the device screen are considered as viewers. In one or more embodiments, machine learning models trained on facial positioning and gaze estimation can help distinguish between casual bystanders and intentional viewers. One or more embodiments can continuously monitor the scene, dynamically adjusting to changes in the number of detected faces. Once the device detects more than one active viewer who is not the primary user, one or more embodiments can trigger an automatic mode switch to enter the PFNM mode of operation. To maintain efficiency and privacy, one or more embodiments may perform on-device processing to avoid transmitting facial recognition data externally. In one or more embodiments, when the PFNM mode of operation is entered, sensitive notifications may be routed to a personal second electronic device and not shown/surfaced on the display of the electronic device.

As shown in FIG. 2C, personal electronic devices AR glasses 262, smartwatch 264, and wireless earphones 266 are shown. Person 242 may be a primary user of the electronic device 202. Person 242 may be wearing one or more of the personal electronic devices (262, 264, and 266). In one or more embodiments, the at least one personal second electronic device is a device from among a group comprising a smartwatch, augmented reality eyewear, and wireless earphones, and the disclosed process includes identifying a device type of the at least one personal second electronic device. In addition to the personal electronic devices depicted in FIG. 2C, other types of personal electronic devices may be used with disclosed embodiments. For example, the personal electronic devices can include bone conduction headphones that transmit sound through the bones of the skull, allowing the user to hear audio privately while keeping their ears open to surrounding sounds. As another example, the personal electronic devices can include smart rings that can provide haptic feedback or subtle audio cues when paired with a companion device such as electronic device 202. Further, the personal electronic devices can include non-AR smart glasses that can include built-in directional speakers that deliver audio discreetly without covering the ears. As yet another example, the personal electronic devices can include smart contact lenses that can include embedded displays that enable viewing of private notifications. Other personal electronic devices may be used with other embodiments.

As shown in FIG. 2C, the notification 248 (FIG. 2B) is not shown on the display 204 in FIG. 2C, but instead, the contents of the notification and/or indication of arrival of the notification is rerouted to at least one second, personal electronic device, such as AR glasses 262, smartwatch 264, and/or wireless earphones 266. The indication can be an audible indication, such as indicated at 267 for wireless earphones 266. The indication can be a visual indication, such as indicated at 265 for smartwatch 264 or at 263 for AR glasses 262. Person 242 may wear/use one or more of the personal second electronic devices while viewing content 208, along with persons 222 and/or 232. Now, with the privacy-focused notification mode enabled, the primary user of the electronic device 202 using at least one of the second, personal electronic devices, can receive the information corresponding to the contents of, and/or the arrival of, notification 248, while the other persons in proximity, person 222 and/or person 232, are not exposed to the notification 248 or its contents. In this way, disclosed embodiments can protect the privacy of users while still enabling timely delivery of important notifications.

In one or more embodiments, the personal electronic devices may support wear detection and/or biometric identification techniques to provide information about whether a given personal electronic device is currently being worn and/or currently being worn by a user that is the primary user of the electronic device (e.g., smartphone). The wear detection techniques can include use of capacitive sensors and skin conductance. For example, smartwatches and AR glasses can use capacitive touch sensors to detect skin contact. The wear detection techniques can include use of infrared sensors. For example, wireless earbuds and AR glasses can use IR sensors to detect when they are being worn. The wear detection techniques can include use of heart rate sensors. For example, a smartwatch may utilize PPG (Photoplethysmography) to detect heart rate. The wear detection techniques can include use of motion sensors. For example, a personal electronic device can use motion patterns to infer if they are being worn (e.g., smartwatch detecting movement patterns that resemble wrist movements, while earphones detect head movements).

In one or more embodiments, notifications are presented on a personal electronic device only if the personal electronic device is determined to be actively being worn. In one or more embodiments, notifications are presented on a personal electronic device only if the personal electronic device is determined to be actively being worn by the primary user of the primary electronic device. In this way, for situations when another person is using the personal electronic device (e.g., a parent lends his smartwatch to his child), the SPS notifications are not surfaced/indicated on the personal electronic device.

Accordingly, in one or more embodiments, in addition to determining if the personal electronic device is being worn, the personal electronic device may further support biometric identification techniques to identify that a primary user is currently wearing/using the personal electronic device. The biometric identification techniques can include use of heart rate and/or heart rate variability (HRV). As an example, a person's heart rate pattern and HRV can be unique, allowing smartwatches to authenticate the wearer. If the detected heart rate pattern does not match the primary user, sensitive notifications can be blocked from being rendered and presented on the smartwatch. The biometric identification techniques can include ear canal mapping. As an example, wireless earbuds can use the shape of the ear canal (measured via acoustic resonance or other techniques) to identify the wearer. If the detected ear shape does not match the primary user, notifications can be rerouted. The biometric identification techniques can include facial recognition and/or voice recognition. As an example, AR glasses equipped with cameras and/or microphones can use facial recognition and/or voice recognition to verify the wearer's identity. Other biometric identification techniques may be used in one or more embodiments.

In some embodiments, the primary electronic device (e.g., electronic device 202 of FIG. 2C) initiates a status query to one or more connected personal electronic devices to determine wear status and primary user status. The status query can include sending a message from the primary electronic device to the one or more personal electronic devices. In one or more embodiments, the primary electronic device receives a response from the one or more personal electronic devices that indicates a wear status (if the personal electronic device is currently being worn or not), and/or if the personal electronic device is currently being worn by the primary user of the primary electronic device. In one or more embodiments, if no reply message is received from a personal electronic device, it is inferred that that personal electronic device is currently not being worn.

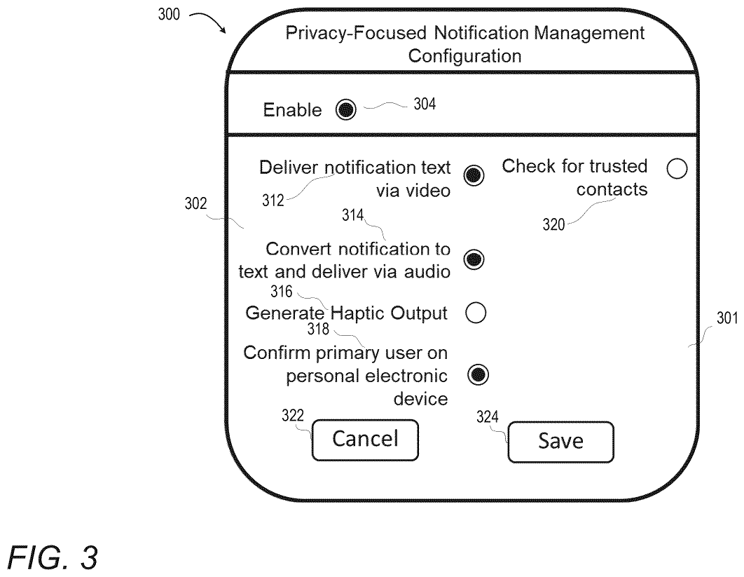

FIG. 3 illustrates an exemplary user interface for privacy-focused notification management configuration, according to one or more embodiments. Device 300 includes display 302 on which user interface 301 is rendered and presented. The user interface 301 can include an option to enable the privacy-focused notification management feature 304, which is indicated as selected in FIG. 3. The user interface 301 can further include one or more user-customizable options. The user-customizable options can include an option 312 to deliver notification text via a video display (e.g., a screen of a smartwatch, AR glasses, etc.). As shown in FIG. 3, option 312 is indicated as enabled. The user-customizable options can include an option 314 to convert notification text to audio and deliver the contents via audio (e.g., to wireless earbuds). As shown in FIG. 3, option 314 is indicated as enabled. The user-customizable options can include an option 316 to generate a haptic output in response to receiving an incoming notification (e.g., to a smartwatch). As shown in FIG. 3, option 316 is indicated as disabled. The user-customizable options can include an option 318 to confirm a primary user on a personal electronic device in order to reroute notifications to that personal electronic device. As shown in FIG. 3, option 318 is indicated as enabled. When the option 318 is enabled, the primary user check is performed prior to sending notification information to the personal electronic device. The option 318 can be useful because some personal electronic devices may not support biometric identification, in which case, the option 318 can be disabled by the user. The option 318 can be set by the user based on the type of personal electronic device they are using and/or their security needs. The user-customizable options can include an option 320 to check for trusted contacts. As shown in FIG. 3, option 320 is indicated as disabled. When the option 320 is enabled, the detected persons are checked to determine if the persons are indicated as trusted contacts. The determination of being a trusted contact can be based on facial recognition and/or identification of nearby electronic devices, such as smartphones that are associated with entries in a contact database within the electronic device, and indicated as trusted contacts. In this way, notifications can be surfaced if everyone in proximity is deemed to be a trusted contact (e.g., a brother and sister watching a video together on an electronic device). A cancel option 322, when invoked, discards unsaved settings of the user interface of FIG. 3, and exits the user interface. A save option 324, when invoked, saves the settings of the user interface of FIG. 3 to memory, and exits the user interface. More, fewer, and/or different options may be present in one or more embodiments.

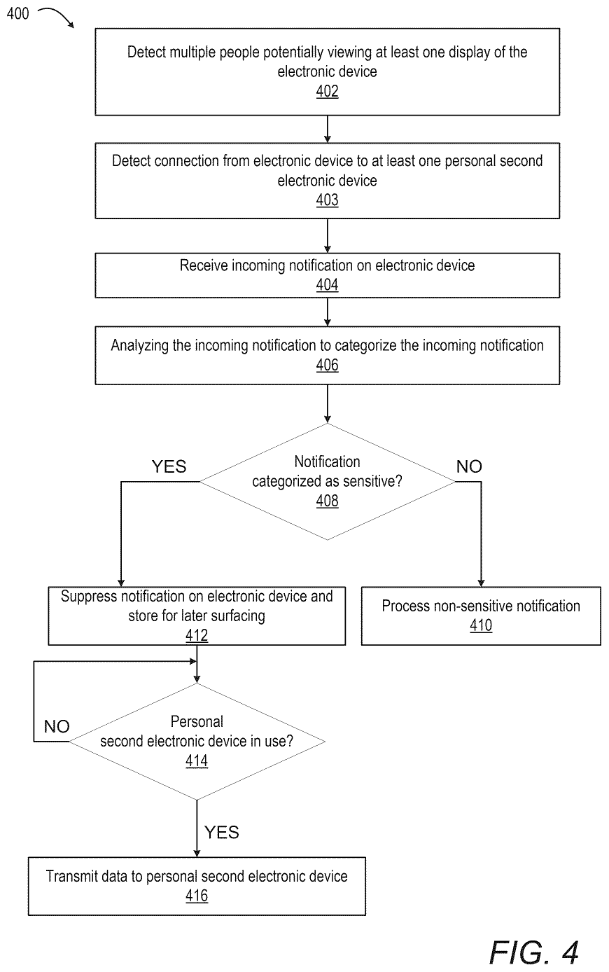

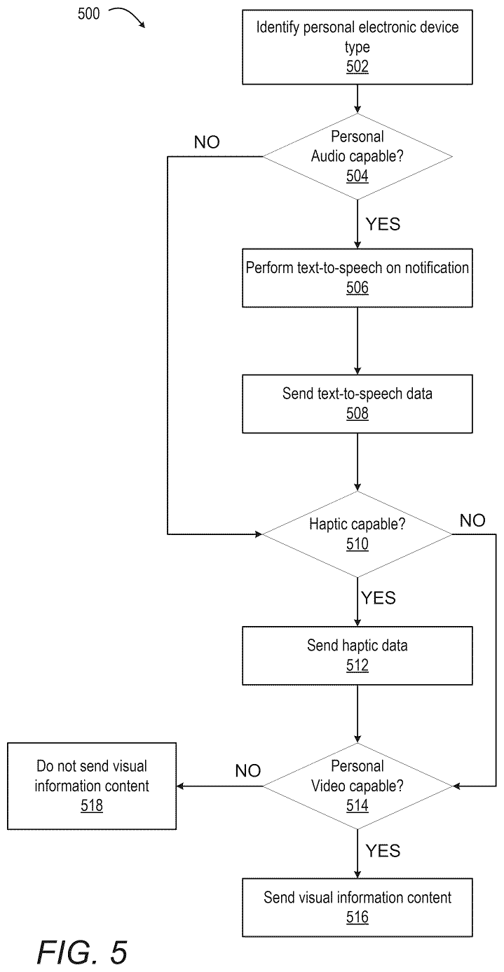

Referring now to the flowcharts presented by FIG. 4 and FIG. 5, the descriptions of the methods in FIG. 4 and FIG. 5 are provided with general reference to the specific components and features illustrated within the preceding FIG. 1-3. Specific components referenced in the methods of FIG. 4 and FIG. 5 may be identical or similar to components of the same name used in describing preceding FIG. 1-3. In one or more embodiments, processor 112 (FIG. 1A) configures electronic device 100 (FIG. 1A) to provide the described functionality of the methods of FIG. 4 and FIG. 5 by executing program code for one or more modules or applications provided within system memory 120 of electronic device 100, including PFNM module 125.

FIG. 4 depicts a flowchart of a computer-implemented method for implementing privacy-focused notification management configuration on an electronic device, according to one or more embodiments. The method 400 starts at block 402, where a condition of multiple people potentially viewing at least one display of the electronic device is detected. In one or more embodiments, the detection of multiple people potentially viewing the at least one display of the electronic device can include use of a microphone on the electronic device to detect sounds of multiple voices, an electronic scan of nearby devices to determine that other devices, possibly associated with other people, are nearby, facial recognition and/or eye gaze tracking, and/or other suitable techniques. The method 400 then continues to block 403, where a connection from an electronic device to at least one personal second electronic device is detected. In embodiments, the electronic device can be a smartphone, and the personal second electronic device can be a smartwatch, AR glasses, wireless earbuds, wireless earphones, and/or other suitable personal electronic device. The method 400 continues to block 404, where an incoming notification is received on the electronic device. The incoming notification can include a notification of an incoming text message, email message, application message, and so on. The method 400 continues to block 406, where the incoming notification is analyzed to categorize the incoming notification.

In one or more embodiments, the source of the notification may be used as a criterion to determine if a notification is considered to be sensitive. As an example, notifications originating from banking institutions may be deemed as sensitive, while notifications originating from a weather service may be deemed as not sensitive. The categorization may further include utilizing AI-enabled techniques such as natural language processing (NLP) to perform an analysis of the content to determine if the incoming notification is a text-based notification containing natural language, and if the content is sensitive or not. One or more embodiments may utilize named entity recognition (NER) to detect specific types of sensitive information. The detected information can include personal identifiable information (PII), which can include names, addresses, telephone numbers, social security numbers, email addresses, and the like. The detected information can include financial information, such as credit card numbers, bank account details, and/or transactions. The detected information can include medical information, such as prescriptions, diagnoses, and/or patient records. The detected information can include security-related information such as passwords and authentication codes. Other types of sensitive information may be detected in one or more embodiments. A level of sensitivity can be determined by the AI-enabled techniques. One or more embodiments can include: performing a machine learning process on the incoming notification; determining a sensitivity level of the incoming notification based on the machine learning process; and transmitting data corresponding to the incoming notification based on the sensitivity level exceeding a threshold level of sensitivity.

The method 400 continues to block 408, where a check is made to determine if the notification is categorized as sensitive. If, at block 408, the notification is categorized as sensitive, the method 400 then continues to block 412, where the notification is suppressed on the primary electronic device (e.g., smartphone or tablet), and stored on the electronic device for potential surfacing at a later time, on either the electronic device, or a personal second electronic device, if one becomes available. The method 400 then continues to block 414, where a check is made to determine if a connected, personal second electronic device is in use. If, at block 414, it is determined that the personal second electronic device is not in use, then the method 400 returns to block 414 to periodically check if the personal second electronic device is in use. If, at block 414, it is determined that the personal second electronic device is in use, then the method 400 continues to block 416, where data pertaining to the notification is transmitted to the personal second electronic device. The data that is transmitted can include text data, image data, audio data, and/or haptic data. The haptic data can include an instruction/command that is received by the personal second electronic device and causes the personal second electronic device to generate a haptic event (e.g., a vibration), to alert a user of the incoming notification.

If, at block 408, the notification is not categorized as sensitive, the method 400 then continues to block 410, where the notification is processed as a non-sensitive notification. In some embodiments, the non-sensitive notification processing can include surfacing the notification. In some embodiments, the non-sensitive notification processing can include deferring the surfacing of the notification, or ignoring of the notification.

FIG. 5 depicts a flowchart of a computer-implemented method presenting additional embodiments for implementing privacy-focused notification management on an electronic device, indicating details of sending audio, visual and/or haptic data, according to one or more embodiments. The method 500 starts at block 502, where a personal electronic device type is identified. In one or more embodiments, a Bluetooth Class of Device (CoD) identifier is used to identify a device category and capabilities. In embodiments, the CoD major class and/or minor class are used for identifying personal second electronic devices. As non-limiting examples, wireless earbuds typically have a major class of ‘audio’ and a minor class of ‘headphones’ and accordingly, are deemed to be personal electronic devices. In contrast, Bluetooth speakers typically have a major class of ‘audio’ and a minor class of ‘loudspeaker’ and accordingly, are deemed to not be personal electronic devices. Smartwatches and AR glasses typically have a major class of ‘wearable’ and accordingly, are deemed to be personal electronic devices. One or more embodiments may utilize Bluetooth Low Energy (BLE) GATT (Generic Attribute Profile) services to determine if a second electronic device is a personal electronic device. As an example, wireless earbuds typically are indicated as an audio sink that supports hands-free profile (HFP). The support of HFP can be used to infer a device is a personal electronic device. In contrast, a Bluetooth speaker is typically indicated as an audio sink, but is missing the HFP support, and accordingly, can be deemed to not be a personal electronic device. Other techniques, such as Bluetooth profiles and/or MAC address lookup, may be used instead of, or in addition to, the aforementioned techniques for identifying a personal electronic device type.

The method 500 continues to block 504 where a check is made to determine if the personal device type is capable of outputting personal audio. In this context, ‘personal audio’ indicates audio that is only audible to the wearer/user of the personal electronic device. If it is determined at block 504 that the personal electronic device is not personal audio capable, then the method 500 continues to block 510. If, at block 504, it is determined that the personal electronic device is personal audio capable, then the method 500 continues to block 506, where a text-to speech process is performed on the notification. The method 500 then continues to block 508, where the text-to-speech data is sent to the personal electronic device, such that the personal electronic device can present the audio content corresponding to the notification. Thus, the user wearing wireless earbuds may hear the contents of the incoming notification being spoken. Accordingly, one or more embodiments can include: identifying that the incoming notification is a text-based notification containing natural language; identifying a type of the at least one personal second electronic device as a device that supports generation of audio output; performing text-to-speech conversion on text within the text-based notification to generate audio data corresponding to the incoming notification; and transmitting the audio data to the at least one second electronic device, as the data corresponding to the incoming notification to the at least one second electronic device.

From block 508, the method 500 continues to block 510, where a check is made to determine if the personal electronic device is haptic capable, such as a smartwatch. If it is determined at block 510 that the personal electronic device is not haptic capable, then the method 500 continues to block 514. If, at block 510, the personal electronic device is determined to be haptic capable, the method 500 continues to block 512 where haptic data is sent to the personal electronic device, causing the personal electronic device to generate a haptic response, such as a vibration, or pattern of vibrations that can serve as an indication of arrival of a sensitive notification. Accordingly, one or more embodiments can include: identifying that the at least one personal second electronic device is a type that supports generation of a haptic output; and providing, within the transmitted data, instruction for the at least one second electronic device to generate a haptic output.

From block 512, the method 500 then continues to block 514 where a check is made to determine if a personal electronic device is capable of presenting personal video. In this context, ‘personal video’ indicates video that is only visible to the wearer/user of the personal electronic device (e.g., AR glasses, and/or other AR eyewear). If, at block 514, it is determined that the personal electronic device is capable of presenting personal video, then the method 500 continues to block 516 where visual information content, such as images and/or text data, is sent to the personal electronic device for rendering and presenting to the user. If it is determined at block 514 that the personal electronic device is not personal video capable (e.g., wireless headphones), then the method 500 continues to block 518, where visual information content is not sent. Accordingly, one or more embodiments can include: identifying that the at least one personal second electronic device is a type that supports visual content presentation; and providing, within the transmitted data, visual informational content corresponding to the incoming notification.

The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, the privacy-focused notification management feature of disclosed embodiments offers significant advantages by ensuring that time-sensitive and/or private notifications are discreetly delivered to the intended recipient, even when they are watching videos with a group on a smartphone or tablet. Instead of displaying notifications directly on the primary device screen, where they could be seen by others, the privacy-focused notification management feature reroutes notifications to personal electronic devices such as AR glasses, wireless earbuds, and smartwatches. For AR glasses, the notification appears only in the user's field of view, making it invisible to others. Wireless earbuds can alert the wearer with a subtle tone or sound, and the notification can be converted to speech for hands-free listening. Similarly, a smartwatch can provide a haptic alert, such as a vibration, along with a visual display of the message, allowing the user to discreetly check important information without interrupting the shared experience. One or more embodiments may further activate the PFNM mode of operation upon detecting multiple people proximal to the electronic device while the electronic device is currently casting video content onto another electronic device, such as via Google Cast, Apple Airplay, Miracast, and/or other suitable protocols.

Furthermore, beyond manual activation, in disclosed embodiments, the privacy-focused notification management feature can intelligently enable itself based on environmental conditions. For example, when a video is playing on the smartphone or tablet and multiple people are detected nearby, the system can automatically engage privacy mode. The presence of others can be determined through person detection processes using audio and image data from the microphones and cameras of the electronic device, as well as by scanning for nearby WiFi and/or Bluetooth signals to detect other electronic devices. One or more embodiments can include: performing a detection process to determine that more than one person is viewing the at least one display of the electronic device; and in response to determining that more than one person is viewing the at least one display of the electronic device, triggering the electronic device to automatically enter the PFNM mode of operation. One or more embodiments can include: performing a person detection process to determine a number of persons proximal to the electronic device; and in response to detecting two or more persons, automatically entering the PFNM mode of operation.

Furthermore, disclosed embodiments can check if these detected devices belong to trusted contacts. In one or more embodiments, if at least one nearby device is not linked to a trusted contact, the privacy-focused notification management feature can activate automatically, ensuring sensitive information remains protected. This intelligent approach allows users to remain aware of urgent messages without compromising privacy, while also maintaining an uninterrupted and immersive content-watching experience with friends, family, or colleagues. One or more embodiments can check if any of the identified persons in proximity is not a trusted contact, and prevent surfacing of notifications. In some embodiments, if all persons identified are trusted contacts, the notification can be surfaced. Referring again to FIG. 2C, in one or more embodiments, electronic device 202 can detect electronic device 224 and electronic device 234 to determine possible presence of other people nearby, and may query electronic device 224 and electronic device 234 to determine possible identities of the nearby people. One or more embodiments can include performing a detection process to determine an identity of persons proximal to the electronic device; and in response to determining that at least one person from the persons is not a trusted contact, triggering the electronic device to automatically enter the PFNM mode of operation. The detection process can include utilizing encrypted handshake information, identifying a device name, BLE advertising data, MAC addresses, and/or other identifying information, and comparing that with device information stored in a trusted contact list of the electronic device.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device comprising at least one display;
a communications subsystem for communicatively connecting the electronic device with at least one second electronic device;
a memory having stored thereon a privacy-focused notification management (PFNM) module; and
at least one processor communicatively coupled to each of the at least one output device, the communications subsystem, and the memory, the at least one processor executing program code of the PFNM module and is configured to cause the electronic device to:
detect a connection to at least one personal second electronic device;
determine that the at least one display is potentially being viewed by at least one other person who is not a primary user;
in response to determining that the at least one display is potentially being viewed by at least one other person who is not the primary user, enter a privacy-focused notification management (PFNM) mode of operation, while the connection to the at least one personal second electronic device is detected;
receive an incoming notification;
analyze the incoming notification to categorize the incoming notification into one of a first category of sensitive, personal/private, or security-related (SPS) notifications and a second category of general notifications; and
based on the incoming notification being categorized into the first category:
suppress the incoming notification from being presented on the electronic device;
determine an active usage status for the at least one personal second electronic device; and
transmit data corresponding to the incoming notification to the at least one personal second electronic device for presentation via the at least one personal second electronic device, in response to determining the at least one personal second electronic device is being used by the primary user.

2. The electronic device of claim 1, wherein further, the at least one processor is configured to cause the electronic device to:
identify that the at least one personal second electronic device is a type that supports visual content presentation; and
provide, within the transmitted data, visual informational content corresponding to the incoming notification.

3. The electronic device of claim 1, wherein further, the at least one processor is configured to cause the electronic device to:
identify that the at least one personal second electronic device is a type that supports generation of a haptic output; and
provide, within the transmitted data, instruction for the at least one second electronic device to generate a haptic output.

4. The electronic device of claim 1, wherein further, the at least one processor is configured to cause the electronic device to:
identify that the incoming notification is a text-based notification containing natural language;
identify a type of the at least one personal second electronic device as a device that supports generation of audio output;
perform text-to-speech conversion on text within the text-based notification to generate audio data corresponding to the incoming notification; and
transmit the audio data to the at least one second electronic device, as the data corresponding to the incoming notification to the at least one second electronic device.

5. The electronic device of claim 1, wherein the at least one personal second electronic device is a device from among a group comprising a smartwatch, augmented reality eyewear, and wireless earphones; and the at least one processor is further configured to identify a device type of the personal second electronic device.

6. The electronic device of claim 1, wherein to enter the PFNM mode of operation, the at least one processor is further configured to:
perform a person detection process to determine a number of persons proximal to the electronic device; and
in response to detecting two or more persons, automatically enter the PFNM mode of operation.

7. The electronic device of claim 6, wherein to enter the PFNM mode of operation, the at least one processor is further configured to:
in response to determining that at least one person from the persons is not a trusted contact, trigger the electronic device to automatically enter the PFNM mode of operation.

8. The electronic device of claim 1, wherein:
to categorize the incoming notification, the at least one processor is further configured to cause the electronic device to:
perform a machine learning process on the incoming notification;
determine a sensitivity level of the incoming notification based on the machine learning process; and
wherein to transmit data corresponding to the incoming notification to the at least one second electronic device, the at least one processor is further configured to cause the electronic device to activate transmission of the data corresponding to the incoming notification based on the sensitivity level exceeding a threshold level of sensitivity.

9. A method comprising:
detecting, by at least one processor of an electronic device that includes memory, at least one display, and communications subsystem for communicatively connecting the electronic device with at least one second electronic device, a connection to at least one personal second electronic device;
determining that the at least one display is potentially being viewed by at least one other person who is not a primary user;
in response to determining that the at least one display is potentially being viewed by at least one other person who is not the primary user, entering a privacy-focused notification management (PFNM) mode of operation, while the connection to the at least one personal second electronic device is detected;
receiving an incoming notification;
analyzing the incoming notification to categorize the incoming notification into one of a first category of sensitive, personal/private, or security-related (SPS) notifications and a second category of general notifications; and
based on the incoming notification being categorized into the first category:
suppressing the incoming notification from being presented on the electronic device;
determining an active usage status for the at least one personal second electronic device; and
transmitting data corresponding to the incoming notification to the at least one personal second electronic device for presentation via the at least one personal second electronic device, in response to determining the at least one personal second electronic device is being used by the primary user.

10. The method of claim 9, further comprising:
identifying that the at least one personal second electronic device is a type that supports visual content presentation; and
providing, within the transmitted data, visual informational content corresponding to the incoming notification.

11. The method of claim 9, further comprising:
identifying that the at least one personal second electronic device is a type that supports generation of a haptic output; and
providing, within the transmitted data, instruction for the at least one second electronic device to generate a haptic output.

12. The method of claim 9, further comprising:
identifying that the incoming notification is a text-based notification containing natural language;
identifying a type of the at least one personal second electronic device as a device that supports generation of audio output;
performing text-to-speech conversion on text within the text-based notification to generate audio data corresponding to the incoming notification; and
transmitting the audio data to the at least one second electronic device, as the data corresponding to the incoming notification to the at least one second electronic device.

13. The method of claim 9, wherein:
the at least one personal second electronic device is a device from among a group comprising a smartwatch, augmented reality eyewear, and wireless earphones; and
the method further comprises identifying a device type of the at least one personal second electronic device.

14. The method of claim 9, further comprising:
performing a person detection process to determine a number of persons proximal to the electronic device; and
in response to detecting two or more persons, automatically entering the PFNM mode of operation.

15. The method of claim 14, further comprising:
in response to determining that at least one person from the persons is not a trusted contact, triggering the electronic device to automatically enter the PFNM mode of operation.

16. The method of claim 9, further comprising:
performing a machine learning process on the incoming notification;
determining a sensitivity level of the incoming notification based on the machine learning process; and
transmitting data corresponding to the incoming notification based on the sensitivity level exceeding a threshold level of sensitivity.

17. A computer program product comprising a non-transitory computer readable medium having program instructions that when executed by a processor of an electronic device comprising at least one display and communications subsystem for communicatively connecting the electronic device with at least one second electronic device, configure the electronic device to perform functions comprising:
detecting a connection to at least one personal second electronic device;
determine that the at least one display is potentially being viewed by at least one other person who is not a primary user;
in response to determining that the at least one display is potentially being viewed by at least one other person who is not the primary user, entering a privacy-focused notification management (PFNM) mode of operation, while the connection to the at least one personal second electronic device is detected;
receiving an incoming notification;
analyzing the incoming notification to categorize the incoming notification into one of a first category of sensitive, personal/private, or security-related (SPS) notifications and a second category of general notifications; and
based on the incoming notification being categorized into the first category:
suppressing the incoming notification from being presented on the electronic device;
determining an active usage status for the at least one personal second electronic device; and
transmitting data corresponding to the incoming notification to the at least one personal second electronic device for presentation via the at least one personal second electronic device, in response to determining the at least one personal second electronic device is being used by the primary user.

18. The computer program product of claim 17, further comprises program instructions for performing functions comprising:
identifying that the at least one personal second electronic device is a type that supports visual content presentation; and
providing, within the transmitted data, visual informational content corresponding to the incoming notification.

19. The computer program product of claim 17, further comprises program instructions for performing functions comprising:
identifying that the at least one personal second electronic device is a type that supports generation of a haptic output; and
providing, within the transmitted data, instruction for the at least one second electronic device to generate a haptic output.

20. The computer program product of claim 17, further comprises program instructions for performing functions comprising:
identifying that the incoming notification is a text-based notification containing natural language;
identifying a type of the at least one personal second electronic device as a device that supports generation of audio output;
performing text-to-speech conversion on text within the text-based notification to generate audio data corresponding to the incoming notification; and
transmitting the audio data to the at least one second electronic device, as the data corresponding to the incoming notification to the at least one second electronic device.
